(19) United States
(12) Patent Application Publication
(10) Pub. No.: US 2004/0050252 A1
(43) Pub. Date: Mar. 18, 2004

(54) Air cleaner assembly and process

(76) Inventors: Lee S. Wernholm, Burton, MI (US); Gordon J. Rutland, Flint, MI (US)

Correspondence Address: VINCENT A. CICHOSZ, DELPHI TECHNOLOGIES, INC., Legal Staff, Mail Code: 480-410-202, P.O. Box 5052, Troy, MI, 48007-5052, US

(21) Appl. No.: 10/244,243

(22) Filed: Sep. 16, 2002

(51) Int. Cl. B01D 53/02

(52) U.S. Cl. 95/143; 95/146; 96/134

(57) ABSTRACT

An air cleaner assembly for an internal combustion engine and process for eliminating fuel emissions from passing into the atmosphere. The air cleaner assembly includes a housing comprising a filter element situated therein, an outlet, and an inlet; and an adsorber panel disposed within the housing, wherein the adsorber panel comprises a pollutant treating material and a substrate.

### BACKGROUND

As internal combustion engines wear, the annular spaces between the pistons and the cylinder tend to increase. In the combustion chamber of each cylinder, an air-fuel mixture is ignited. The expanding gas mixture forces the piston upwards generating power from the engine. In the expansion process, part of the gas mixture is forced between the annular spaces between the piston and the cylinder into the crankcase. In addition, unburned fuel can be present after the internal combustion engine is shut down. These “blow-by” gases, which also include oil mist and unburned fuel, accumulate in the crankcase and must be vented from the crankcase to the atmosphere to prevent a potentially dangerous pressure build-up in the crankcase.

Pollution control laws and regulations restrict the emissions from internal combustion engines. As exhaust gases from internal combustion engines have become cleaner, the blow-by gases have become a more significant fraction of the total pollution generated from internal combustion engines. In many localities, the pollution control laws and regulations are such that vapors from the internal combustion engines must be cleaned prior to discharge into the atmosphere.

### SUMMARY

Disclosed herein is an air cleaner assembly for use with an engine, processes for reducing fuel emissions into the external environment and a process for assembling the air cleaner assembly. The air cleaner assembly comprises a housing comprising an outlet in fluid communication with an engine combustion chamber and an inlet in fluid communication with an external environment, wherein during operation an air stream flows from the external environment to the engine combustion chamber; a filter element disposed within the housing, and an adsorber member disposed within the housing, wherein the adsorber panel comprises a pollutant treating material and a substrate.

In accordance with another embodiment, the air cleaner assembly comprises a housing comprising an upper casing including an inlet opening and a lower casing including an outlet opening, wherein the upper casing further comprises a peripheral rim structure adapted to be secured to a complementary rim structure in the lower casing; a filter element disposed within the housing; and an adsorber member disposed within the housing and adapted to receive all fluid flowing between the inlet and outlet openings, wherein the adsorber panel comprises a pollutant treating material and a substrate.

A process for assembling an air cleaner assembly comprises supporting a filter element on a first interior support surface of an air cleaner housing comprising a lower case, an upper case, an inlet and an outlet; supporting an adsorber member on a second interior support surface or on the filter element; and securing the upper case to the lower case to form a tight seal between the upper and lower cases forming the housing, wherein the filter element and the adsorber member are adapted to receive a gas stream flowing between the inlet and the outlet of the air cleaner assembly.

A process for reducing fuel emissions contained within an air cleaner assembly to an external atmosphere, the air cleaner assembly comprising a housing, an inlet, an outlet, and an adsorber member contained therein comprises turning off an engine, wherein the engine is in fluid communication with the outlet opening of the air cleaner assembly; adsorbing fuel vapor or pollutants discharged from the turned-off engine with the adsorber member; operating the engine, wherein a gas stream is drawn from the external environment through the inlet opening to the outlet opening and then to the engine; and desorbing a portion of the adsorbed fuel vapor or pollutants from the adsorber member.

The above-described and other features will be appreciated and understood by those skilled in the art from the following detailed description, drawings, and appended claims.

### BRIEF DESCRIPTION OF THE DRAWINGS

Referring now to the figures wherein the like elements are numbered alike:

FIG. 1 is an exploded perspective view of an air cleaner assembly; and

FIG. 2 is an exploded perspective adsorber panel for use in the air cleaner assembly.

### DESCRIPTION OF THE PREFERRED EMBODIMENT

The present disclosure relates to an air induction system and process for eliminating fuel emissions. More particularly, the present disclosure relates to an air induction system and process for eliminating fuel emissions from an air cleaner assembly, for example, eliminating fuel emissions that accumulate in the air cleaner assembly after shutdown of an internal combustion engine.

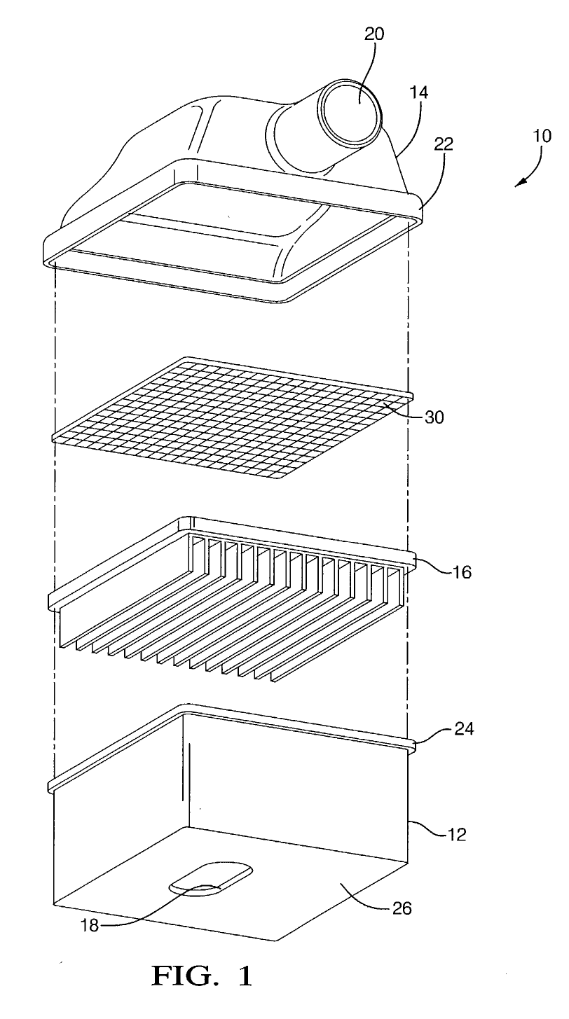

Referring now to FIG. 1, there is shown an exploded perspective view of an air cleaner assembly 10. In general, the air cleaner assembly 10 will be mounted under the hood and to the framework of a vehicle, by securing a flange against a portion of the vehicle frame or framework. Mounting is accomplished through bolts (not shown) extending through apertures (not shown). When so mounted, braces will help support the remainder of the air cleaner assembly 10 projecting at the selected mounting angle, with appropriate resistance to material failure, during use.

The illustrated shapes of the various components that form the air cleaner assembly 10 are exemplary only and can be any general shape desired. The air cleaner assembly 10 generally comprises a lower case 12 and an upper case 14 that houses one or more filter elements 16 for removing particulate matter from a gas stream during operation of the internal combustion engine, and an adsorber member 30 for selectively adsorbing hydrocarbons and like materials, such as those contained in fuel vapor.

The lower and upper cases, 12 and 14 respectively, are preferably injection molded from a synthetic resin, e.g., a thermoplastic. The lower case 12 is shown with a cup-like shape and includes an outlet opening 18 in fluid communication with an engine combustion chamber or chambers through a carburetor or intake manifold. The upper case 14 of the air cleaner assembly 10 has an inverted cup-like shape and inlet opening 20 in fluid communication with the external environment. As previously discussed, the lower 12 and upper 14 cases can be a shape other than that shown, e.g., circular, rectangular, oblong, crescent, and the like. During engine operation, the inlet opening 20 permits the entry of air from the external environment into the air cleaner assembly 10 and through outlet opening 18 to the engine combustion chamber or chambers.

The upper case 14 further includes an outer peripheral rim 22 that is adapted to be clamped or otherwise secured to a complementary rim structure 24 in the lower case 12. Alternatively, the upper case 14 may be secured to the lower case 12 by hinges, bolts, or other means for matingly securing the upper case 14 to the lower case 12. Preferably, the lower 12 and upper 14 cases, when secured, form a tight seal that effectively prevents entry or discharge of gases through the seal. Thus, the only entry or exit for a gas flowing through or contained within the air cleaner assembly 10 is by way of the inlet opening 20 or outlet opening 18.

The one or more filter elements 16 for removing particulate matter from a gas stream produced during engine operation can have an insert or spacer construction that generally includes an outer liner and an inner liner. A media construction can be positioned between the outer liner and inner liner. A variety of materials can be utilized for the outer and inner liners including expanded metal, perforated metal, and plastic liners, as examples. In general, the outer and inner liners should preferably be selected of materials appropriately perforated or otherwise made porous so as not to substantially interfere with airflow through the air cleaner assembly; be of appropriate structural rigidity and strength to contain the media construction, provide the arrangement with sufficient axial strength for the use intended, and protect the media construction from damage. Typical liners have an open area greater than or equal to about 50%, and often greater than or equal to about 60%, or more. Galvanized metal or plastic arrangements are typically preferred. Herein, the combination of the outer liner, inner liner, and media construction will sometimes be referred to as the media pack. The media construction may comprise a pleated media, a depth media, or other like media construction. Depth media generally refers to a staged or graduated arrangement of filtration filaments and pore sizes whereas pleated media generally refers to the use of a sheet material that is folded. If pleated or depth media is used, in general, paper, fiber media, and the like, are preferred, e.g., cellulose fibers, and synthetic fibers.

The one or more filter elements 16 may also include first and second opposite end caps. The end caps preferably comprise a compressible elastomer, such as a polyurethane; however, a harder material can also be used as one or more of the end caps, with the media and liners secured to the end caps by a potting material such as an adhesive, for example, a plastisol adhesive.

The one or more filter elements 16 can be supported by a support surface (not shown) about an inner perimeter of the lower case 12, may be supported by the lower case rim 24, may be supported by contact with a bottom surface 26 of the lower case 12, and/or may be attached to the upper case 14. In a preferred embodiment, the one or more filter elements 16 is a panel-type filter element (as shown in FIG. 1), which is fitted and supported by one of the prescribed methods to the lower case 12 such that any gases flowing through the upper 14 and lower 12 cases, flow through the filter element 16. In this manner, particulate matter can be removed from a gas stream flowing therethrough during operation of the engine.

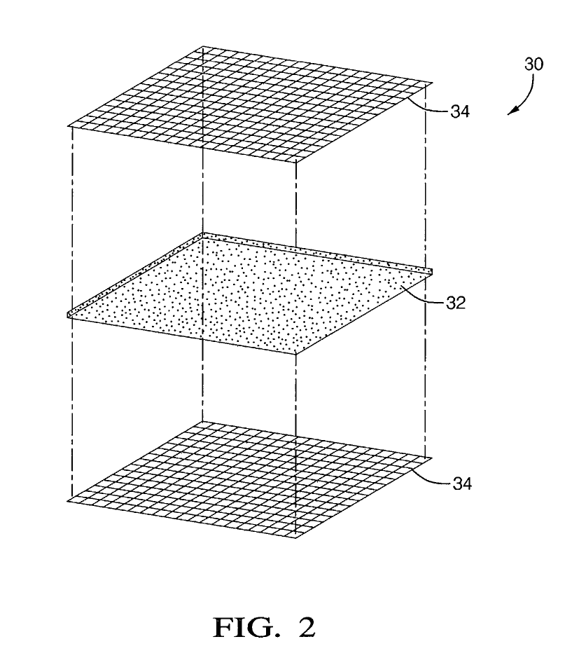

An adsorber member 30 is disposed within the housing 12, 14 of the air cleaner assembly 10. The adsorber member 30 preferably comprises a pollutant treating material and a substrate 32 (see FIG. 2). The adsorber member 30 selectively adsorbs pollutant materials and prevents the pollutant materials from being discharged into the atmosphere. Although the types of pollutants may vary widely depending on the environmental conditions to which the adsorber member 30 is exposed, contemplated pollutants include, but are not limited to, saturated and unsaturated hydrocarbons, certain carbon oxides (e.g., carbon monoxide), nitrates, sulfides, ozone, and the like, and combinations comprising at least one of the foregoing. Such pollutants may typically comprise 0 to 400 parts per billion (ppb) ozone, 1 to 20 parts per million carbon monoxide, 2 to 3,000 ppb unsaturated hydrocarbons such as C₂ to C₂₀ olefins and partially oxygenated hydrocarbons such as alcohols, aldehydes, esters, ketones, and the like. In a preferred embodiment, the pollutant treating material selectively adsorbs unsaturated hydrocarbons such as those unsaturated hydrocarbons utilized in fuels and byproducts caused by combustion. In this manner, any backflow of gases from the engine, such as those gases that may backflow from the engine compartment to the external atmosphere after the engine is shut off, is selectively adsorbed by the adsorber panel.

The pollutant treating material may include adsorbers, such as silicate materials, zeolites, activated carbon, activated carbons, sulfides, and the like, and combinations comprising at least one of the foregoing. The pollutant treating materials are coated, impregnated, or otherwise disposed onto the substrate 32. The amount of pollutant treating material employed is preferably effective to reduce fuel emissions and other pollutants from a gas stream passing through the adsorber member 30 and will depend on the particular materials utilized as well as the intended application.

Suitable silicate materials include, but are not limited to silicates belonging to the phyllosilicate class of silicates. Suitable phyllosilicates include, but are not limited to, smectites, palygorskites, sepiolites, tuperssuatsiaite, yofortierite, kalifersite, falcondoite, loughlinite, and combinations comprising at least one of the foregoing phyllosilicates, wherein smectites, palygorskites, sepiolites, and combinations comprising at least one of the foregoing phyllosilicates are preferred, and wherein sepiolites are particularly preferred. The silicate material may be either pure, i.e. 100% silicates, or it may comprise other materials, such as, but not limited to, alkaline ions including lithium, sodium, potassium, cesium, and combinations comprising at least one of the foregoing. These alkaline ion silicate materials are preferably prepared by substituting magnesium (Mg⁺²) ions of the silicate materials with the alkaline ions.

Suitable zeolites include, but are not limited to beta zeolite, dealuminated zeolite Y, and the like, and combinations comprising at least one of the foregoing zeolites.

The pollutant treating materials may also comprise catalytic materials including metals, such as platinum, palladium, rhodium, iridium, osmium, magnesium, ruthenium, tantalum, zirconium, yttrium, cerium, nickel, copper, and the like, as well as oxides, alloys, and combinations comprising at least one of the foregoing catalytic materials, wherein nickel, palladium, and combinations comprising at least one of the foregoing catalyst metals are preferred.

The substrate 32 can include any material designed for use in a spark ignition or diesel engine environment and which has the following characteristics: (1) capable of operating at elevated temperatures dependent upon the device's location and the type of system (e.g., gasoline or diesel); (2) capable of withstanding exposure to pollutants, hydrocarbons, nitrogen oxides, carbon monoxide, particulate matter (e.g., soot and the like), carbon dioxide, and/or sulfur; and (3) have sufficient surface area and structural integrity to support the pollutant treating material, and, where desired, a catalyst. Some possible substrate materials include ceramic, cordierite, silicon carbide, metal, metal oxides (e.g., alumina, and the like), glasses, polymers, and the like, and combinations comprising at least one of the foregoing materials. Some ceramic materials include “Honey Ceram”, commercially available from NGK-Locke, Inc, Southfield, Michigan, and “Celcor”, commercially available from Corning, Inc., Corning, N.Y. These materials are preferably in the form of monoliths (e.g., a honeycomb structure, and the like). Preferred monolith supports are carriers of the type having a plurality of fine, parallel gas flow passages extending therethrough from an inlet face to an outlet face of the carrier so that the passages are open to air flow entering and passing through the monolith.

Although the substrate 32 of the adsorber member 30 can have any size or geometry, the size and geometry are preferably chosen to optimize surface area in a given design parameters. As such, the substrate 32 may be in the form of foam, pleated media, sheets, monoliths, a combination comprising at least one of the foregoing substrate types, and the like, such that flow of gases through the air cleaner assembly can occur. More preferably, the substrate and pollutant treating materials are chosen so as to minimize any pressure drop through the adsorber member 30. The substrate may have a honeycomb geometry, with the combs through-channel having any multi-sided or rounded shape, with substantially square, triangular, pentagonal, hexagonal, heptagonal, or octagonal or similar geometries preferred due to ease of manufacturing and increased surface area. Also, although each comb forming the honeycomb may be of a different size, the layer preferably comprises a honeycomb structure wherein all combs are of about equal size. The layer may comprise about 60 to about 600 or more fluid passageways (cells) per square inch of cross section. Preferably the passages are essentially straight from their inlet to their outlet and are defined by walls in which the pollutant treating material may be coated as a washcoat so that the gases flowing through the passages contact the pollutant treating material.

In a preferred embodiment as shown in FIG. 2, the adsorber member 30 comprises at least one layer of an activated carbon coated onto a foam sheet substrate 32 and sandwiched between open mesh sheets 34. The adsorber member 30 can further include other layers, with or without the pollutant treating material, depending on the desired application. The porosity and thickness of activated carbon foam sheet 32 should be selected so as to not substantially interfere with airflow through the air cleaner assembly 10. Preferably, the thickness of the activated carbon foam sheet 30 is about 0.125 inches to about 6 inches, more preferably about 0.25 inches to about 3 inches, and even more preferably, about 0.5 inches to about 2 inch.

The open mesh sheets 34 provide structural rigidity to the adsorber member 30 and are preferably injection molded from a plastic material, more preferably a thermoplastic material, generally impervious to the operation environment. Suitable thermoplastics include polyesters, polyamides (e.g., nylons), and the like. Alternatively, the open mesh sheet can be fabricated from an epoxy coated metal wire such as aluminum, stainless steel, and the like. The activated carbon foam sheet 32 is sandwiched between the open mesh sheets 34, which sheets are then attached together about an outer perimeter, e.g., spot-welded or soldered together.

During operation, the pollutant treating materials (e.g., activated carbon) contained within the adsorber member 30 can selectively adsorb the fuel vapor (e.g., hydrocarbons and/or other pollutants depending on the pollutant treating material) and temporarily retain the fuel vapor until the air cleaner assembly 10 is purged. Introducing outside air, or purge air, such as during engine operation desorbs the fuel vapor and carries the desorbed fuel vapor to the engine compartment where combustion occurs.

The adsorber member 30 can be disposed within the air cleaner in the manner previously described for the one or more filter elements 16. For example, the adsorber member 30 can be supported by a support surface about the inner perimeter of the lower case 12 or attached to the upper case 14. The support surface may be continuous or discrete. Alternatively, the adsorber member 30 can rest on the filter element 16. Clips, screws, gravity, or other attachment means can be employed to secure the adsorber member 30 to the lower case 12, upper case 14, or filter element 16.

In a preferred embodiment, the adsorber member 30 is seated against interior wall surfaces provided by upper 14 or lower 12 case such that an airtight seal exists between the outer perimeter of the adsorber member 30 and the interior wall surfaces of the upper or lower cases. Similarly, where the adsorber member 30 is supported by the filter element 16, an airtight seal is preferably formed between the outer perimeter of the adsorber member and the interior wall of the housing. As such, the adsorber member 30 generally conforms to the shape of the opening defined by a cross-section of the upper and lower cases. In this manner, all gases contained or flowing into the air cleaner assembly 10 will flow through the adsorber member 30. For example, fuel vapors that may accumulate in the air cleaner assembly 10 after engine shutoff will pass through the adsorber member 30 in order to enter the atmosphere.

The order of the adsorber member 30 and filter elements 16 can vary without changing the performance of the air cleaner assembly. For example, the adsorber member 30 can be configured to first receive the gas stream from the inlet conduit 20, which gas stream can then pass through the filter element(s) 16 can first receive the gas stream from the inlet conduit 20. In a preferred embodiment, air entering the air cleaner assembly 10 through the inlet conduit 20 first passes through the adsorber member 30 prior to passing through the filter element 16.

During engine operation, the air cleaner assembly 10 will draw air from the external environment through the inlet opening 20 and into the housing defined by the lower 12 and upper 14 cases. The air will then flow through the adsorber panel 30 and the filter elements 16 contained within the air cleaner assembly 10 and exit the outlet opening 18 to a combustion chamber of the engine. In this manner, particulate matter will be filtered by the filter elements 16 from the air stream prior to being introduced to the combustion chamber. Moreover, pollutants adsorbed by the adsorber member 30 may become desorbed and carried to the engine combustion chamber as a result of the airflow through the air cleaner assembly 10. After the engine is shutdown, fluid from the combustion chamber, e.g., air, pollutants, oil mist, and the like, may backflow or diffuse into the air cleaner assembly 10. In order to exit the air cleaner assembly 10 and discharge into the atmosphere, the fluid must pass through the filter element 16 and the adsorber member 30. The adsorber member 30 will selectively and advantageously adsorb the pollutants contained within the fluid, such that pollutants will not be discharged into the atmosphere.

Current emission requirements under the Clean Air Act are becoming more rigid, e.g., Super Ultra Low Emission Vehicles (SULEV), and consequently, automotive manufacturers must continue to reduce emissions. Advantageously, the air cleaner assembly 10 can be used to reduce, if not eliminate, fuel gases and other pollutants from entering into the atmosphere through the air cleaner assembly, e.g. fuel gases that may accumulate in the air cleaner casing after engine shutdown. Hydrocarbons and other pollutants are selectively adsorbed by the adsorber panel 30, thereby effectively eliminating fuel emissions from the air induction system when the engine is shut down. In contrast, air cleaner assemblies without an adsorber member fail to remove fuel emissions from the air induction system when the engine is shut down, which can undesirably pass into the atmosphere.

While the disclosure has been described with reference to an exemplary embodiment, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular embodiment disclosed as the best mode contemplated for carrying out this disclosure, but that the disclosure will include all embodiments falling within the scope of the appended claims.

What is claimed is:

1. An air cleaner assembly comprising:
a housing comprising an outlet in fluid communication with an engine combustion chamber and an inlet in fluid communication with an external environment, wherein during operation an air stream flows from the external environment to the engine combustion chamber;
a filter element disposed within the housing, and
an adsorber member disposed within the housing, wherein the adsorber panel comprises a pollutant treating material and a substrate.

2. The air cleaner assembly according to claim 1, wherein the adsorber member is adapted to be in fluid communication with all fluid flowing between the inlet and the outlet.

3. The air cleaner assembly according to claim 1, wherein the pollutant treating material comprises activated carbon, and wherein the substrate comprises a foam.

4. The air cleaner assembly according to claim 1, wherein the adsorber member is sandwiched between first and second open mesh sheets, wherein an outer perimeter of the first open mesh sheet is fixedly attached to an outer perimeter of the second open mesh sheet.

5. The air cleaner assembly according to claim 1, wherein the adsorber member is supported on an inner support surface of the housing.

6. The air cleaner assembly according to claim 1, wherein the adsorber member is supported by the filter element.

7. The air cleaner assembly according to claim 1, wherein the pollutant treating material is selected from the group consisting of silicate materials, activated carbon, catalysts, sulfides, and combinations comprising at least one of the foregoing pollutant treating materials.

8. The air cleaner assembly according to claim 1, wherein the substrate is a material selected from the group consisting of ceramic, cordierite, silicon carbide, metal, metal oxides, glasses, polymers, and combinations comprising at least one of the foregoing materials.

9. The air cleaner according to claim 4, wherein the first and second open mesh sheets comprise a thermoplastic or an epoxy coated metal wire.

10. An air cleaner assembly comprising:
a plastic housing comprising an upper casing including an inlet opening and a lower casing including an outlet opening, wherein the upper casing further comprises a peripheral rim structure adapted to be secured to a complementary rim structure in the lower casing;
a filter element disposed within the housing; and
an adsorber member disposed within the housing and is adapted to receive all fluid flowing between the inlet and outlet, wherein the adsorber panel comprises a pollutant treating material and a substrate.

11. The air cleaner assembly according to claim 10, wherein the pollutant treating material is selected from the group consisting of silicate materials, activated carbon, catalysts, sulfides, and combinations comprising at least one of the foregoing pollutant treating materials.

12. The air cleaner assembly according to claim 10, wherein the pollutant treating material comprises activated carbon, and wherein the substrate comprises a foam.

13. The air cleaner assembly according to claim 12, wherein the adsorber member is sandwiched between first and second open mesh sheets, wherein an outer perimeter of the first open mesh sheet is fixedly attached to an outer perimeter of the second open mesh sheet.

14. A process for assembling an air cleaner assembly, the process comprising:
supporting a filter element on a first interior support surface of an air cleaner housing comprising a lower case, an upper case, an inlet and an outlet;
supporting an adsorber member on a second interior support surface or on the filter element; and
securing the upper case to the lower case to form a tight seal between the upper and lower cases forming the housing, wherein the filter element and the adsorber member are adapted to receive a gas stream flowing between the inlet and the outlet of the air cleaner assembly.

15. The process according to claim 14, wherein the adsorber member comprises an activated carbon foam layer sandwiched between a first and second open mesh sheet.

16. A process for reducing fuel emissions contained within an air cleaner assembly to an external atmosphere, the air cleaner assembly comprising a housing, an inlet, an outlet, and an adsorber member contained therein, the process comprising:
turning off an engine, wherein the engine is in fluid communication with the outlet opening of the air cleaner assembly;
adsorbing fuel vapor or pollutants discharged from the turned-off engine with the adsorber member;
operating the engine, wherein a gas stream is drawn from the external environment through the inlet opening to the outlet opening and then to the engine; and
desorbing a portion of the adsorbed fuel vapor or pollutants from the adsorber member.
